(19) United States
(12) Patent Application Publication
(10) Pub. No.: US 2017/0054767 A1
(43) Pub. Date: Feb. 23, 2017

(54) TRANSFERRING APPLICATION STATE BETWEEN DEVICES

(71) Applicant: Google Inc., Mountain View, CA (US)

(72) Inventors: Benjamin GOLDSMITH, San Francisco, CA (US); Jennifer Shien-Ming Chen, San Francisco, CA (US); Alexander Friedrich Kuscher, San Francisco, CA (US)

(21) Appl. No.: 14/828,450

(22) Filed: Aug. 17, 2015

(51) Int. Cl. H04L 29/06

(52) U.S. Cl. CPC H04L 65/1083; H04L 65/1073

(57) ABSTRACT

A system and method is disclosed for transferring application state between devices. A server stores state objects for applications operating on a first device. The server receives, from a second device, a request for device state information associated with the first computing device. In response to the request, the server provides device state information to the second device, the device state information comprising an application enumeration of the applications operating on the first device. In response to receiving a selected one of the applications in the application enumeration, the server provides the second device a state object corresponding to the selected application, and the second device opens a local instance of the application using state provided by the state object.

### TECHNICAL HELD

The subject technology relates generally to the transferring of application state between different devices.

### BACKGROUND

Users often interact with multiple applications across multiple devices associated with the user's account. For example, a user may begin a task (e.g., writing an email) on the user's mobile device, switch to a different activity, and then attempt to resume the original task on a different device (e.g., a laptop). Resuming the task on the other device may involve additional time to load and/or execute a program for resuming the task and/or loading information required for resuming the task. In some cases, a corresponding application for resuming the task may be unavailable.

### SUMMARY

The subject technology provides a system and computer-implemented method for transferring application state between devices. In one or more implementations, a computer-implemented method comprises receiving, from a first computing device, one or more state objects corresponding to applications operating on the first computing device, receiving, from a second computing device remote from the first computing device, a request for device state information associated with the first computing device, providing, in response to the request, the device state information to the second computing device, the device state information comprising an application enumeration of the applications operating on the first computing device, receiving, from the second computing device, an application selection corresponding to a selected application of the provided enumeration, and providing, to the second computing device and in response to receiving the application selection, a state object corresponding to the selected application from the received one or more state objects. Other aspects include corresponding systems, apparatuses, and computer program products for implementation of the computer-implemented method.

In one or more implementations, a computer-implemented method comprises receiving, from a server, an application enumeration of applications operating on one or more remote computing devices associated with a user account, providing the application enumeration for display at a global application interface associated with the user account, receiving, at the global application interface, an application selection corresponding to a selected application of the provided application enumeration, requesting, based on the received application selection, a state object corresponding tote selected application from the server, and receiving the state object requested from the server. Other aspects include corresponding systems, apparatuses, and computer program products for implementation of the computer-implemented method.

In one or more implementations, a system comprises one or more processors, and a memory media having instructions stored thereon. When executed, the instructions cause the one or more processors to store, for a first computing device, one or more state objects corresponding to applications operating on the first computing device, receive, from a second computing device remote from the first computing device, a request for an application enumeration of the applications operating on the first computing device, provide, in response to the request, the application enumeration, receive, from the second computing device, an application selection corresponding to a selected application of the provided enumeration, and provide, to the second computing device and in response to receiving the application selection, a state object corresponding to the selected application from the stored one or more state objects. Other aspects include corresponding apparatuses, methods, and computer program products for implementation of the foregoing system.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of an example system for transferring application state between devices.

FIG. 2 depicts example components and data flow for transferring application state between devices.

FIG. 3 depicts an example user interface for use in for transferring application state between devices.

FIG. 4 depicts a flow diagram of an example process for transferring application state between devices.

FIG. 5 is a diagram depicting an example electronic system for use in connection with transferring application state between devices.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those Skilled in the art that the subject technology is not limited to the specific details set forth herein and may be practiced without these specific details. In some instances, well-known structures and components are shown in block diagram form in order to avoid obscuring the concepts of the subject technology.

The subject technology provides a mechanism for transferring application state between devices. A server is provided that receives and stores state objects corresponding to applications operating on computing devices associated with a user account. A client device (e.g., a computer or smartphone) associated with the user account may request to view applications operating on other devices associated with the user account. On receiving such a request, the server may provide the client device with device state information associated with the other devices, including an application enumeration (e.g., list or other representation) of the applications operating on devices. The client device then informs the server of a selected one of the applications based on a user selection from the application enumeration, and the server provides a state object corresponding to the selected application from the previously received one or more stored state objects.

On the client side, the client device may determine one or more computing devices associated with a user account to which a user of the client device is authenticated. For example, the client device may query the server (e.g., by querying the user account) for devices associated with (or authenticated to) the user account. A device enumeration of the determined computing devices may then be provided to a global application interface operating on the client device. In one or more implementations, the global application interfaces provides for “global” management and transfer of state information (e.g., as state objects) across all devices linked to the user account. On receiving from the global application interface a user selection corresponding to one or more computing devices, the client device may request device state information for the selected devices from the server. The server then sends to the client device the device state information, including an application enumeration of applications operating on the selected computing devices, and the client device provides the application enumeration to the global application interface.

The user may then select an application from the provided application enumeration. On receiving the selected application, the client device requests and receives a state object corresponding to the selected application from the server. The client device may then use the state object to open a local instance of the selected application with state and settings identical to a remote instance of the selected application that is currently operating on one of the selected computing devices.

The global application interface may be used, for example, to view all applications currently operating on devices connected to the user account, or all applications for which state information has been stored at the server. Applications may be displayed from a group of displayed applications ordered by device or, in some implementations, a group of devices may be displayed and applications for a selected one of the displayed devices presented to the user. In some implementations, the global application interface may be displayed upon the user performing a predetermined gesture (e.g., a pinch or pinch-expand gesture on a desktop).

The operation of the system, and global application interface, may be bi-directional. For example, a user may use the global application interface to instantiate a local instance of an application currently running on another device. Alternatively, the user may drag a representation of an application currently operating on the user's device to a representation of another device displayed in the global application interface to transfer a state object to the other device and open an instance of the application on the other device.

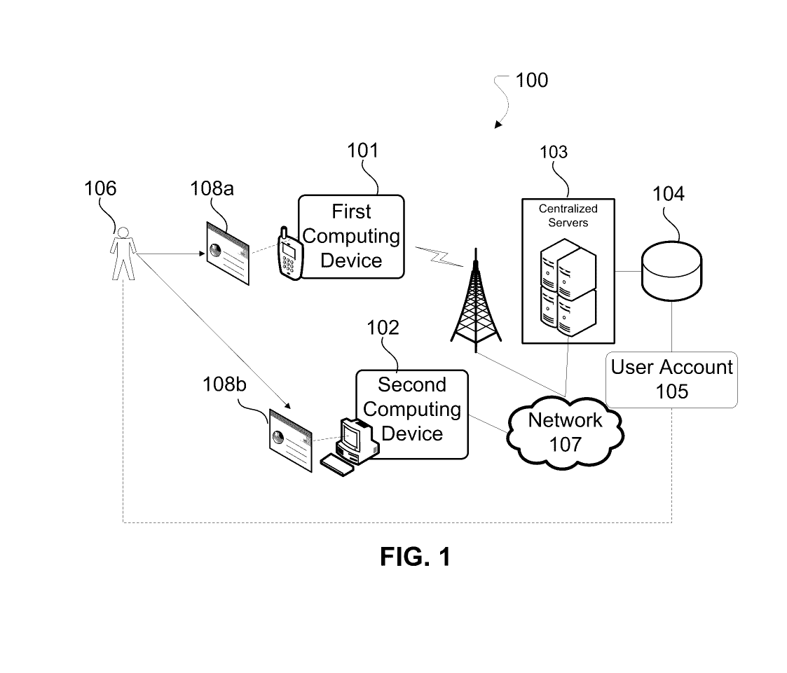

FIG. 1 is a diagram of an example system 100 for transferring application state between devices, according to one or more aspects of the subject technology. A system 100 may include one or more computing devices 101, 102, one or more centralized servers 103, and a remote storage 104 (for example, a database). Computing devices 101, 102 may each be one of a smartphone, GPS navigation device, or personal computer, tablet computer, PDA, a television or other display device with one or more location-aware computing devices embedded therein or attached thereto, or the like.

According to various implementations, computing devices 101 and 102 may be tied to a user account 105. Accordingly, a user 106 is authorized to use certain features of a respective device 101, 102 by authenticating to user account 105, User account 105 may be, for example, a cloud-based or web-based user account or may be an enterprise account (e.g., LDAP account), and may function as a universal account for multiple devices. In this regard, information stored in connection with the user account may be centrally located on a third computing device, for example, on a server 103 (e.g., in a “data cloud”). Server 103 may be operably connected to, for example, first and second computing devices 101, 102 over a network 107 (for example, a LAN, WAN, WiFi, cellular network, or the Internet). Remote storage 104 may store information in connection with user account 105 (e.g., state Objects). The functionality of server 103 and remote storage 104 may be implemented on the same physical server or distributed among a plurality of servers. Moreover, remote storage 104 may take any form such as relational databases, object-oriented databases, file structures, text-based records, or other forms of data repositories.

Computing devices 101, 102 may store (e.g., locally) information settings and state information within the state objects for applications operating on the devices. A state object may be a memory-resident data object associated with each application. Each state object may persist in memory like a cookie and/or persist in a local non-volatile memory after the application is closed. A state object, or the information therein, may be automatically transmitted to server 103 for storage at remote storage 104. In another aspect, a state object or the information therein may only be transmitted if the application, or the device on which the application is operating, has been registered and/or authenticated to user account 105, or if manually authorized or initiated by user 106.

Each computing device 101, 102 may be configured to connect to server 103 and to synchronize local state information with state objects stored in remote storage 103. In one aspect, first computing device 101 may send one or more state objects to server 103, and server 103 may receive and store the state objects in remote storage 103 so that they may be accessed and synchronized with second computing device 102, even when device 101 is offline. Server 103 may also store other information, including the last time each device, application, or state object was synchronized.

The synchronization, storage, and/or transfer of state objects may be between different types of computing devices 101, 102. For example, various applications may be installed on a smartphone as well as a desktop or laptop computer. As tong as these applications and/or the device on which they are operating are associated with user account 105, state objects for the applications may be uploaded and stored on remote storage 103 for access by any of the devices.

The various connections between computing devices 101 and 102, server 103, and storage 104 may be made over a wired or wireless connection. Computing devices 101 and 102 may be co-located within a defined area. For example, the devices may be connected to the same LAN or WiFi network. Computing devices 101 and 102 may be in different locations such as at the user's home and place of employment.

According to various aspects, computing devices 101 and 102 may be configured to load and execute one or more user interfaces 108a, 108b for interaction with server 103 and for the management or transfer of state objects. User interface 108 may be a desktop interface provided by a desktop or mobile operating system, or a user interface provided by a stand-alone application (e.g., a web-browser or web-enabled application) executing on the device and managed by the operating system. Interface 108 may be opened using, e.g., a predetermined gesture. For example, user 106 may perform a pinch-expand gesture (e.g., a reverse pinch) on a touch screen of computing device 102 to open interface 108b. As will be discussed further, the user interface 108 of each device may be used to review, at a global level, applications operating on devices linked to user account 105 and to local open selected ones of those applications on the device associated with user interface 108 (operating, e.g., as a global application interface).

Server 103 may receive and store state objects for devices associated with user account 105 and, upon receiving a request for state information from one of the devices, server 103 may make a determination as to which computing devices are currently associated (e.g., registered) with user account 105 and/or currently authenticated to user account 105. Server then may provide an enumeration of all applications operating across the account-linked devices to one or more of the devices based on the determination. For example, computing device 102 may request an enumeration of devices linked to user account 105. Server 103 may then determine the devices currently linked to the account and provide the enumeration of devices to user interface 108b for display to user 106.

User 106 may then select one of the devices at user interface 108b to open locally on device 102. In this regard, server 103 may receive, from interface 108b, a device selection corresponding to a selected computing device of the device enumeration. In response to receiving the device selection, server 103 may determine an application enumeration of applications operating on the selected computing device, and provide the application enumeration to interface 108b. User 106 may then select an application from the application enumeration, and computing device 102 provides the selected application to server 103. Server 103 then retrieves a state object corresponding to the selected application from, e.g., remote storage 104 and provides the state object to computing device 102. Computing device 102 receives the state object from server 103 and then opens a local instance of the selected application based on the received state object. The local instance is opened with state and settings identical to a remote instance of the selected application that is currently operating on the selected computing device.

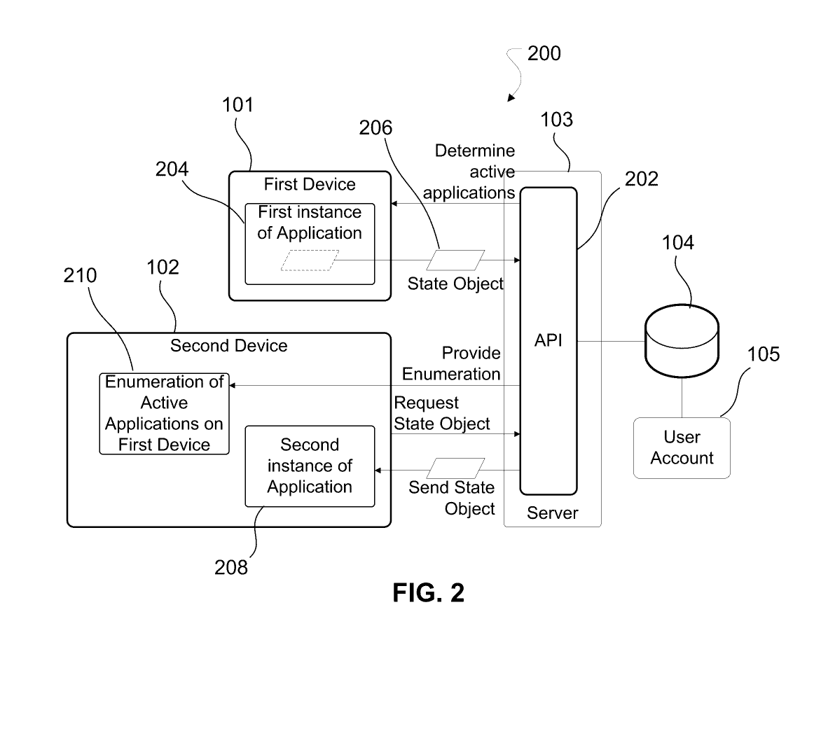

FIG. 2 depicts example components and data flow for transferring application state between devices, according to one or more aspects of the subject technology. A system 200 may include one or more application programming interfaces (APIs) 202 for facilitating communication between different computing devices 101, 102 and a remote server 103. In one aspect, an API 202 may be located on server 103 and provided to computing devices operating in connection with user account 105. Using API 202, a computing device 101 may persist application state information, including settings and state, to server 103 for access by other devices, such as computing device 102, linked to user account 105.

in one or more implementations, applications are authorized to store state objects 206 by registering the applications with server 103, e.g., when the user is authorized to user account 105. In this manner, each application becomes “account-linked” and is associated in user account 105 with its corresponding device(s) on which it is installed and operating.

In one or more implementations, computing device 101 may store application-specific state information, such as application state and settings (and/or configuration information) for an application operating on device 101, and then mirror that information on server 103 for the generation of other instances of the application on other devices. As depicted in FIG, 2, when information is stored or updated by a first instance 204 of an application, a state object 206 may automatically mirrored, stored or updated at server 103. Additionally or in the alternative, state object 206 may be provided to server 103 on request from the server 103, e.g., when server 103 receives a similar request from an account-linked device.

In one or more implementations an information monitoring service, running concurrently with API 202 on server 103, may monitor information stored server 103. On an update of an application at any of the account-linked devices, server 103 may broadcast a signal to all registered devices, notifying them that the stored information was updated. In one or more implementations, each device may register an event listener with server 103 and server 103 may notify the registered devices by calling their registered event listeners. In one or more implementations, each application may periodically call API 202 to update state objects stored in storage 104.

As described previously, access to API 202 may be based on authentication to or association with user account 105, in this regard, transfer of state objects 206 stored at storage 103 may be made available only to devices 101, 102 that can be verifiably associated with user account 105. For example, on a user authentication to user account 105 at device 101, device 101 may provide state object 206 to server 103 for storage in storage 104. On a user authentication to user account 105 at device 102, device 102 may request and receive state objects from all devices linked to user account 105, including state object 206 provided by device 101. Similarly, once information has been stored or updated in storage 104, sever 103, via API 202, may provide state object 206 to a second instance of the application 208 operating, e.g., second computing device 102.

In the depicted example, a state object 206 corresponding to a first instance 204 of an application operating on first computing device 101 is received by server 103 from device 101. Device 101 may, e.g., access API 202 to upload state object 206. The upload of state object 206 may occur upon start-up of the application corresponding to the state object or upon start-up of device 101, e.g., on authentication of the application or device 101 to user account 105. State object 206 may then be updated to server 103 periodically, during operation of the application or device 101.

Server 103 receives a request from computing device 102 for device state information associated with computing device 101. The request may be generally directed to device state information for all devices linked to user account 105, or device state information corresponding to computing device 101. In response to the request, server provides the requested information to computing device 102 including, e.g., an enumeration 210 of the applications operating on computing device 101. Enumeration 210 may then be displayed on an interface 108b provided by device 102.

Server 103 may then receive from device 102 an application selection corresponding to a selected application of the provided enumeration 210, in response to receiving the application selection, server 103 may access storage 104, retrieve state object 206 (provided by device 101) and provide state object 206 to device 102. Device 102 may then open a second, local instance 208 of the selected application based on received state object 206. In this regard, second instance 208 may include settings and state of the application which are identical to first instance 204, which may be currently operating on a respective one of the one or more remote computing devices.

In one or more implementations, server 103 may receive an indication from a device to open a remote instance of an application operating on the device on a different device, with the remote instance having settings and state identical to that of the current instance. For example, server 103 may receive a request from device 101 to open second instance 208 on device 102 based on state object 206 from first instance 204 on device 101. In this regard, user 106, operating device 101, may transfer of state object 206 to device 102 and initiate generation of the remote instance. The request may be initiated at user interface 108a by way of a user gesture. For example, user 106 may drag a representation of the application corresponding to state object 206 to a representation of device 102.

Server 103 may receive state object 206 and an identification of computing device 102 from computing device 101. State object 206 may then be sent to computing device 102 based on the received identification of device 102 and predetermined registration information for device 102. For example, server 103 may provide configuration options upon registration of devices and a user may select what types of applications may be transferred and/or automatically opened on the device being registered. In one or more implementations, server 103 may receive state object 206 without a device identification, and hold state object 206 until it can be delivered to the next operably connected device (e.g., when the next device is authenticated to user account 105). Additionally or in the alternative, server 103 may hold state object 206 until the next time the identified device is operably connected to server 103.

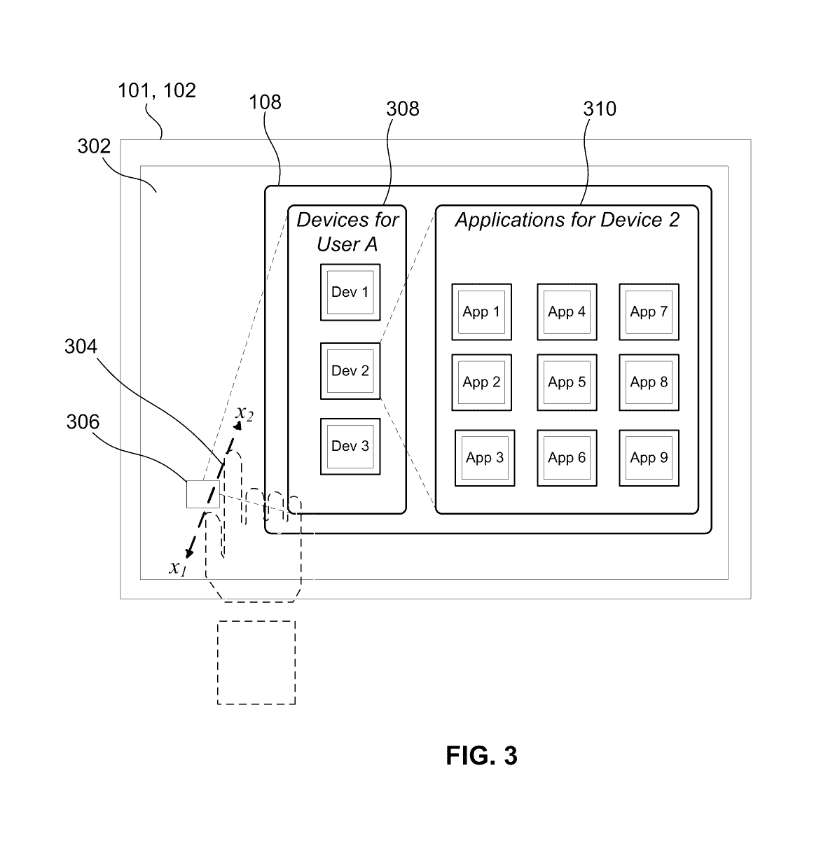

FIG. 3 depicts an example user interface 108 for use in transferring application state between devices, according to one aspect of the subject technology. User interface 108 may be displayed on a display screen 302 of client computing device 101, 102. Display screen 302 may be touch-sensitive such as to receive input through contact with a surface of the screen and touch-related gestures. Display screen 302 may display a number of icons, virtual buttons and other controls for the execution management, and/or manipulation of one or more applications and/or application features.

User interface 108 may be integrated with or accessed from a master interface 302 of, e.g., an operating system (e.g., as a virtual desktop) or for an application, such as a web browser 308 or a social network application. In this regard, user interface 108, when activated, may be displayed above and at least partially overlapping a virtual desktop, including, for example, one or more applications or application features. In some aspects, user interface 108 may float, and may be repositioned by a user. User interface 108 may be generated, for example, by instructions provided by the operating system or embedded within an associated application (for example, scripting language embedded within a webpage).

User interface 108 may be accessed by, e.g., a user gesture 304 performed on a virtual desktop displayed by display screen 302. For example, user gesture 304 may be a drag action performed by a pointer device such as with a mouse while holding down an action button, or a touch-related gesture such as a single or multiple (e.g., two, three, four or more) finger swipe, pinch action, or pinch-expand action, or other predetermined gesture to signal the device to activate user interface 108. User gesture 304 may be a continuous swipe in a predetermined pattern between two points from x₁ to x₂. In one or more implementations, user interface 108 may be activated by activating (e.g., clicking or tapping on) an icon or other representation 306 corresponding to user interface 108 displayed on, e.g., the virtual desktop of display screen 302.

User interface 108, when activated, may display an enumeration 308 of devices linked to user account 105. Enumeration 308 may be determined, e.g., based on device information provided by server 103. For example, when user interface 108 is activated, user interface 108 may send a request to server 108 for the device information, and server 103 may return the device information, including enumeration 308 to user interface 108. In this regard, the devices of enumeration 308 may be limited to devices that were previously registered with user account 105. Once enumeration 308 is displayed, the user may select one or more devices (e.g., “Dev 2” of FIG. 3) from enumeration 308 to view applications operating on the selected device(s). In response to the selection, user interface 108 may request, and server 103 may provide, an application enumeration 310 of applications operating on the selected computing device.

Device 101, 102 receives and displays application enumeration 310 on user interface 108. Application enumeration 310 may include a representation such as an icon for each application (e.g., “App 1” to “App 9” in FIG. 3) operating on the selected device(s) “Dev 2”). The applications of enumeration 310 may be limited to applications that were previously registered with user account 105, e.g., for a corresponding registered device(s) that hosts the application(s). Once enumeration 310 is displayed, the user may select one or more applications from enumeration 310 for which to receive state information from server 103. In response to the selection, user interface 108 may request, and server 103 may provide to the device, a state object 206 corresponding to a selected application. When state object 206 is received, the device may open a local instance of the selected application based on the received state object. In this regard, the local instance comprising settings and state of the application which are identical to a remote instance of the selected application that is currently operating on the selected device (e.g., “Dev 2”).

While FIG. 3 depicts displaying enumeration 308 before displaying enumeration 310 for a selected device, applications for all devices, or a subset of applications for all devices, may be displayed together on interface 108, e.g., without first selecting a device. For example, on activating user interface 108, server 103 may provide all applications for all devices that are registered with user account 105. Enumeration 308 may be displayed together with enumeration 310 (now including all applications), and devices may be selected or deselected to display a subset of the applications in enumeration 310.

Additionally or in the alternative, user interface 108 may display a one or more applications operating on the same device as user interface 108. A user may drag a representation of a local instance of an application to one of the devices displayed, e.g., in enumeration 308, causing a state object 206 for the local instance to be sent to the selected device. Where the application does not have a locally active instance, server 103 may send a previously stored state object 206 to the selected device.

As described previously, a local instance of a selected application may be opened based on a state object 206 received from server 103, with the local instance having settings and state of the application which are identical to a remote instance of the selected application, in one example, the selected application may be a web browser with the remote instance of the web browser operating, e.g., on a mobile device. The received state object 206 may include a web browsing history of, and/or at least one web page currently opened by, the remote instance of the web browser. The local instance of the web browser may then automatically open to view the web page at a location in the web page last viewed by the user in the remote instance. Additionally or in the alternative, the local instance may be automatically configured to allow navigation of web pages according to the web browsing history of the remote instance. For example, once the web browser is opened the user may select the ‘back’ button to navigate backward through a history of web pages viewed in the remote instance of the web browser.

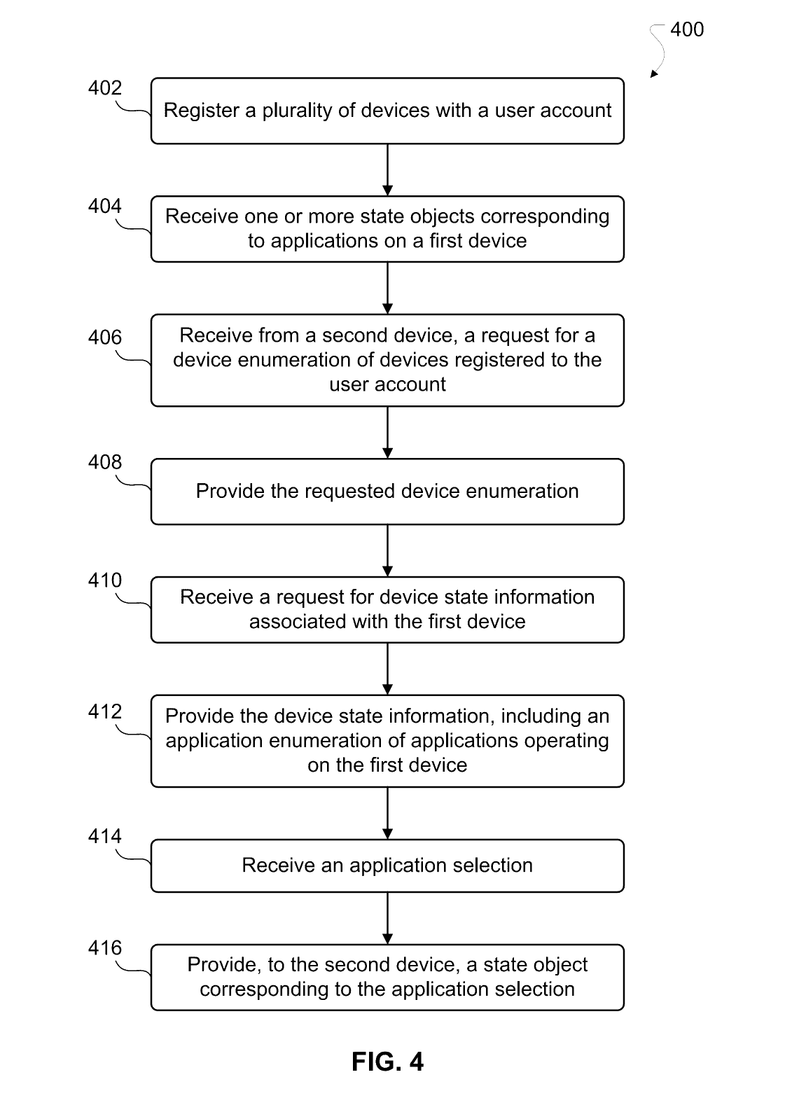

FIG. 4 depicts a flow diagram of an example process 400 for transferring application state between devices, according to aspects of the subject technology. For explanatory purposes, example process 400 is described herein with reference to the components of FIG. 1, FIG. 2, and FIG. 3. Further for explanatory purposes, the blocks of example process 400 are described herein as occurring in serial, or linearly. However, multiple blocks of example process 400 may occur in parallel. In addition, the blocks of example process 400 need not be performed in the order shown and/or one or more of the blocks of example process 400 need not be performed.

In the depicted example flow diagram, server 103 registers a plurality of devices, including first computing device 101 and second computing device 102, with user account 105 (402). First computing device 101 and/or second computing device may be, e.g., a mobile device such as a smartphone, or a notebook, tablet, or desktop computer. While the registration of devices is depicted, server 103 may register applications, individually or in groups, with user account 105 so that the registered applications may be updated between all devices (or a subset of devices) registered with user account 105. Once an application and/or device is registered with user account 105, the application and/or device may store state objects 206 in connection with user account 105.

Server 103 receives from, e.g., first computing device 101 one or more state objects 206 corresponding to applications operating on device 101 (404). As described previously, state objects 206 may be stored when an instance of the application starts on the device, and may be updated to server 103, e.g., at periodic intervals. In one or more implementations, a user of the device has the option to register the applications for which state objects are provided to server 103. For example, the user may open interface 108 and select one or more applications on the device for registering with user account 105. The user also has the option to unregister applications at any time.

Server 103 receives from, e.g., device 102 a request for a device enumeration 308 of devices registered to user account 105 (406) and, in response to the request for the device enumeration, server 105 provides device enumeration 308 to device 102 (408). The request may be received from user interface 108b and provided to server 103 via API 202. The request for device enumeration 308 may be provided in response to an action by the user, or may be automatically made by user interface 108 when user interface is instantiated. In one or more implementations, user interface 108 may periodically poll. server 103 to determine whether new devices have been registered and update enumeration 308 accordingly.

Server 103 receives a request for device state info illation, including an application enumeration 310 of applications, associated with device 101 (410). In the depicted example, the request for device state information identifies the device 101 as being selected from device enumeration 308 In response to the request for device state information, server 103 provides device state information for device 101 to device 102, including application enumeration 310 of the applications operating on device 101 (412). According to various aspects, device 102 (the requesting device) is required to be authenticated to the user account 105 before server 103 provides the device state information (and/or device enumeration) to device 102. Additionally, the request for device state information may be received from, and the device state information may be provided to, a user interface 108 on the requesting device. User interface 108 is, according to various implementations, linked with user account 105 and may provide the mechanism for the user to authenticate device 102 with user account 105. Server 103 provides, when authorized, the device state information to user interface 108 for display of application enumeration 310.

Server 103 then receives, from device 102, an application selection (e.g., made by a user) corresponding to a selected application of the provided enumeration 310 (414), and in response to receiving the application selection, server 103 provides to device 102 a state object 206 corresponding to the selected application (416). As described previously, state object 206 is provided for opening a local instance of the selected application based on a state Object received from a remote instance. The new local instance may include settings and state of the application which are identical to a remote instance of the selected application that is currently operating, or was operating, on a respective one of the one or more remote computing devices registered with user account 105, including device 101. In some aspects, the state object may have also been previously received and stored by an instance of the application previously operating on the same device.

Additionally, a user may use user interface 108 to transfer state objects 206 to a remote device for automatically opening (e.g., without further action by the user) an instance of corresponding application on the remote device, e.g., when the device is next used by the user. In this regard, state object 206 (corresponding to a selected application at user interface 108) is received by server 108 from, e.g., device 101, and provided to the device 102 together with an indication of a remote application operating on device 102 for executing a remote instance of the application in a state provided by the state object. Device 102 receives the indication and opens the corresponding application using information from the received state object. Device 102 (or interface 108b) may first request user confirmation before opening the application.

Many of the features in the above-described example process 400, and related applications, may be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media. include, but are not limited to, CD-ROMs, flash drives, RAM chips, hard drives, EPROMs, etc. The computer readable media, by itself, does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program white remaining distinct software aspects of the subject disclosure, in some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

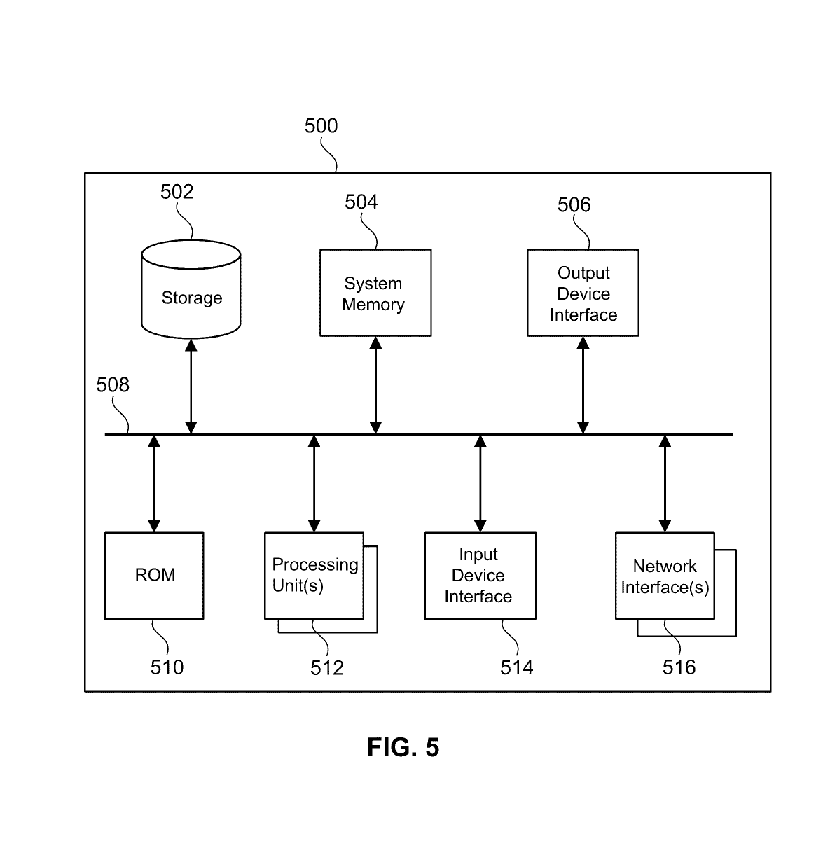

FIG. 5 is a diagram illustrating an example electronic system 500 for use in connection with transferring application state between devices, according to one or more aspects of the subject technology. Electronic system 500 may be a computing device for execution of software associated with the operation of computing device 100, or one or more portions or steps of process 400, or components and processes provided by FIGS. 1-4. In various implementations, electronic system 500 may be representative of first or second computing device 101, 102, or server 103. In this regard, electronic system 500 may be a personal computer or a mobile device such as a tablet computer, laptop, smartphone, PDA, or other touch screen or television with one or more processors embedded therein or coupled thereto, or any other sort of computer-related electronic device having wireless connectivity.

Electronic system 500 may include various types of computer readable media and interfaces for various other types of computer readable media, in the depicted example, electronic system 500 includes a bus 508, processing unit(s) 512, a system memory 504, a read-only memory (ROM) 510, a permanent storage device 502, an input device interface 514, an output device interface 506, and one or more network interfaces 516. In some implementations, electronic system 500 may include or be integrated with other computing devices or circuitry for operation of the various components and processes previously described.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through network interfaces 516. Network interfaces 516 may include, for example, a wireless access point (e.g., Bluetooth or WiFi) or radio circuitry for connecting to a wireless access point. Network interfaces 516 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs), in some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirety restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method, comprising:
receiving, from a first computing device, one or more state objects corresponding to applications operating on the first computing device;
receiving, from a second computing device remote from the first computing device, a request for device state information associated with the first computing device;
providing, in response to the request, the device state information to the second computing device, the device state information comprising an application enumeration of the applications operating on the first computing device;
receiving, from the second computing device, an application selection corresponding to a selected application of the provided enumeration; and
providing, to the second computing device and in response to receiving the application selection, a state object corresponding to the selected application from the received one or more state objects.

2. The method of claim 1, further comprising:
registering, prior to receiving the one or more state objects, a plurality of devices comprising the first computing device and the second computing device with a user account.

3. The method of claim 2, further comprising:
determining the second computing device is authenticated to the user account before providing the device state information to the second computing device.

4. The method of claim 2, further comprising:
receiving, prior to receiving the request for device state information, a request for a device enumeration of devices registered to the user account; and
providing the device enumeration in response to the request for the device enumeration a device enumeration.

5. The method of claim 4, wherein the request for device state information identifies the first computing device as being selected from the device enumeration.

6. The method of claim 2, wherein the request for device state information is received from, and the device state information is provided to, a global application interface on the second computing device, the global application interface being linked with the user account, wherein the device state information is provided to the global application interface on the second computing device for display of the application enumeration.

7. The method of claim 1, wherein updated state objects corresponding to applications operating on the first computing device are received from the first computing device at periodic intervals.

8. The method of claim 1, wherein the state object corresponding to the selected application is provided to the second computing device together with an indication of a remote application operating on the selected computing device and corresponding to the state object for executing the remote application in a state provided by the state object.

9. The method claim 1, wherein first computing device or the second computing device is a mobile device.

10. A method, comprising:
receiving, from a server, an application enumeration of applications operating on one or more remote computing devices associated with a user account;
providing the application enumeration for display at a global application interface associated with the user account;
receiving, at the global application interface, an application selection corresponding to a selected application of the provided application enumeration;
requesting, based on the received application selection, a state object corresponding to the selected application from the server; and
receiving the state object requested from the server.

11. The method of claim 10, comprising:
opening a local instance of the selected application based on the received state object, the local instance comprising settings and state of the application which are identical to a remote instance of the selected application that is currently operating on a respective one of the one or more remote computing devices.

12. The method of claim 11, comprising:
wherein the respective remote computing device is a mobile device.

13. The method of claim 11, wherein the selected application comprises a web browser, and the received state object includes web browsing history of, and at least one web page currently opened by, the remote instance of the selected application,
wherein the local instance of the selected application opens to view the web page at a location in the web page last viewed by the remote instance, and the local instance is configured to allow navigation of web pages according to the web browsing history of the remote instance.

14. The method of claim 10, comprising:
determining, based on device information provided by the server, a device enumeration of the one or more remote computing devices;
providing the device enumeration for display at the global application interface;
receiving, at the global application interface, a device selection corresponding to the respective remote computing device on which the remote instance of the selected application is operating, the respective remote computing device being identified in the device enumeration; and
requesting, from the server in response to receiving the device selection, the application enumeration, wherein the application enumeration is for the respective remote computing device.

15. The method of claim 10, comprising:
generating the global application interface in response to a user-gesture made at a display screen.

16. A system, comprising:
one or more processors; and
a memory media, having instructions stored thereon that, when executed, cause the one or more processors to:
store, for a first computing device, one or more state objects corresponding to applications operating on the first computing device;
receive, from a second computing device remote from the first computing device, a request for an application enumeration of the applications operating on the first computing device;
provide, in response to the request, the application enumeration to the second computing device;
receive, from the second computing device, an application selection corresponding to a selected application of the provided enumeration; and
provide, to the second computing device and in response to receiving the application selection, a state object corresponding to the selected application from the stored one or more state objects.

17. The system of claim 16, wherein the instructions, when executed, further cause the one or more processors to:
register, prior to receiving the one or more state objects, a plurality of devices comprising the first computing device and the second computing device with a user account.

18. The system of claim 17, wherein the instructions, when executed, further cause the one or more processors to:
receive, from the second computing device and prior to receiving the request for device state information, a request for a device enumeration of devices registered to the user account; and
provide the device enumeration to the second computing device in response to the request for the device enumeration a device enumeration.

19. The system of claim 17, wherein the request for device state information is received from, and the device state information is provided to, a global application interface on the second computing device, the global application interface being linked with the user account, wherein the device state information is provided to the global application interface on the second computing device for display of the application enumeration.

20. The system of claim 17, wherein the state object corresponding to the selected application is provided to the second computing device together with an indication of a remote application operating on the selected computing device and corresponding to the state object for executing the remote application in a state provided by the state object.
